(19) United States
(12) Patent Application Publication
(10) Pub. No.: US 2007/0124381 A1
(43) Pub. Date: May 31, 2007

(54) Method and system for providing electronic pickup meetings

(76) Inventor: Mary Ellen Zurko, Groton, MA (US)

Correspondence Address: LOTUS AND RATIONAL SOFTWARE;McGuinness & Manaras LLP, 125 NAGOG PARK, ACTON, MA, 01720, US

(21) Appl. No.: 11/285,513

(22) Filed: Nov. 22, 2005

(51) Int. Cl. G06F 15/16

(52) U.S. Cl. 709/205

(57) ABSTRACT

A method and system for providing real time collaboration sessions among computer users. When a scheduling user selects a group of people for a real-time collaboration session, and some of the desired participants are not currently available, interface options are simultaneously provided that enable the user to either start the collaboration session with the currently available participants, or to invite all participants to join a session at future time determined to be the next time at which all desired users are available. The option of sending the electronic invitation may be provided to and accessed simultaneously with the display of the collaboration session interface, while the real-time collaboration session is underway. An invitation to immediately join a current real time collaboration session may further simultaneously provide the receiver with the options of either joining the session, or of responding by generating an electronic invitation to a future session. Such options may be provided through- any specific type of selectable user interface display objects.

### FIELD OF THE INVENTION

The invention relates generally to software systems for real time group collaboration, and more specifically to a method and system for providing electronic pickup meetings.

### BACKGROUND OF THE INVENTION

As it is generally known, real-time collaboration software has been widely adopted for both business and personal use, allowing various types of synchronous group interaction over a communication network such as the Internet. Real-time collaboration tools are often used to facilitate communication among geographically dispersed users by approximating, as closely as possible, the experience of face-to-face meetings.

One popular example of a real-time collaboration tool is instant messaging. In an instant messaging session, real-time messages are exchanged between two or more users in what is referred to as a “chat” session. Like other real time collaboration tools, instant messaging requires that all participating users be simultaneously online to participate in a collaboration session. Existing real-time collaboration software systems also allow users to participate in video conferences, and/or share program or data objects such as a whiteboard, documents, applications, presentations, and drawings.

A problem with existing systems occurs when a user desires to have a real-time collaboration session with one or more other users, but not all of the other users are currently available. In such a situation, the user wishing to have the real-time collaboration session must choose between proceeding immediately, or scheduling a time in the future for the session. For example, the scheduling user may send a request for an immediate collaboration session, such as a chat invitation, via the real-time collaboration tool. However, the request for immediate collaboration can be effective through the real-time collaboration tool only with regard to those of the desired participants that are understood by the tool to be currently online and available to participate. Thus, those desired participants that are not currently available cannot be included in an immediate collaboration session started in that way. Depending on who is currently available, this may not be acceptable to the scheduling user. To determine whether it makes sense to schedule the real time collaboration session for a future time, the scheduling user must switch to a separate calendar and scheduling tool application user interface to search for a time at which all the desired participants will become available. If that future time is sufficiently close, the scheduling user may decide to use the calendar and scheduling tool to manually generate an electronic invitation and send it to all the desired participants. However, the next time that all desired participants are available may be too far in the future to be useful. In that case, the scheduling user may then have to switch back to the real time collaboration tool interface and generate a chat invitation to only those of the desired participants that are currently available. If during such an immediate session begun with only a subset of the desired participants, it becomes apparent that the meeting requires one or more users that are not participating because they are not currently available, the scheduling user may have to again switch to the calendar and scheduling tool. Thus it is apparent from this example that existing systems may be time consuming and inconvenient to use, requiring a scheduling user to repeatedly switch between separate tools and/or interfaces when attempting to set up a real time collaboration session.

For the above reasons and others it would be desirable to have a new system for arranging and conducting real-time collaboration sessions. The new system should allow a user to conveniently determine whether a collaboration session should be started immediately or scheduled for the future, and/or begin a real-time collaboration session, and/or schedule the real-time collaboration session for a future time.

### SUMMARY OF THE INVENTION

To address the above described and other shortcomings of previous solutions, a new method and system for providing electronic pickup meetings are disclosed. In the disclosed system, when a scheduling user selects a group of people for a real-time collaboration session, and some of the desired participants are not currently available, an interface is generated conveniently enabling the scheduling to start the collaboration session immediately with the currently available participants, or to electronically invite all participants to join a session at a future time at which they are all available.

In a first embodiment, the scheduling user is provided with two selectable display objects, such as graphical buttons, the first of which enables to the scheduling user to begin the real-time collaboration session with those desired participants that are currently available. Selection of the second graphic object provides the scheduling user with an interface to, or automatically generates, an electronic invitation sent to all desired participants, inviting them to a session at a time at which they are all determined to be available. Alternatively, if all desired participants are not currently available for a requested real-time collaboration session, the disclosed system may immediately cause the electronic invitation interface to be presented without user action.

The display object leading to the electronic invitation interface may also be provided to and accessed by the user simultaneously with the display of the real-time collaboration session interface, while the real-time collaboration session is underway. The session time indicated by the electronic invitation, and the invitee list, may further be editable by the scheduling user and/or other of the desired participants. Availability information for the desired participants may be collected from one or more collaboration and scheduling application databases.

In another embodiment, an invitation to join a current real-time collaboration session may provide the receiving user with user interface options of either joining the session, or responding by generating an electronic invitation to a future session. Such options may also be provided, for example, through selectable user interface display objects, such as graphical buttons. The electronic invitation thus provided may be addressed to all the desired participants, and indicate a future session time at which all of the desired participants are available.

A new system for arranging and conducting real-time collaboration software sessions is therefore disclosed that conveniently allows a user to begin a real-time session with those desired participants that are currently available, and/or generate an electronic invitation to a session at a future time at which all desired participants are available.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a first block diagram showing the structure and operation of software components in an illustrative embodiment of the disclosed system;

FIG. 2 is a flow chart showing steps performed by an embodiment of the disclosed system;

FIG. 3 is a simplified screen shot illustrating an example of a user interface provided to a scheduling user to select desired participants for a real-time collaboration session;

FIG. 4 is a simplified screen shot illustrating an example of a user interface generated by an illustrative embodiment in response to a determination that not all users selected for a real-time collaboration session;

FIG. 5 is a simplified screen shot illustrating an example of a user interface generated in response to a scheduling user providing an indication that a real-time collaboration session should be started immediately even though not all desired participants are currently available; and

FIG. 6 is a simplified screen shot illustrating an example of a user interface generated in response to receipt of an invitation to join a real-time collaboration session.

### DETAILED DESCRIPTION OF EXEMPLARY EMBODIMENTS

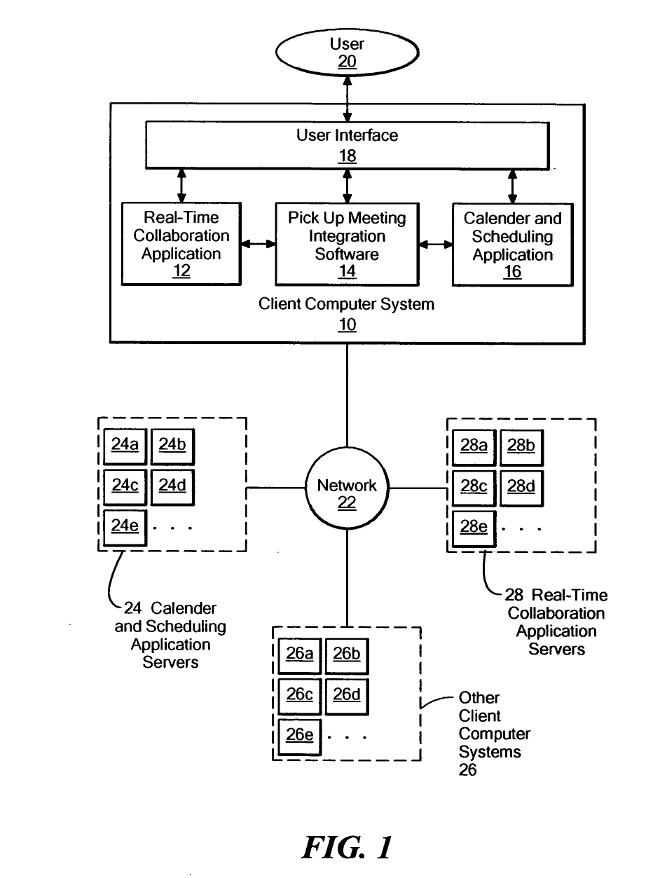

As shown in FIG. 1, an illustrative embodiment of the disclosed system operates using a number of software components executing on at least one computer system, shown for purposes of illustration as the client computer system 10, calendar and scheduling application servers 24, real-time collaboration application servers 28, and other client computer systems 26. Further for purposes of illustration, calendar and scheduling application servers 24 are shown including of computer systems 24a, 24b, 24c, 24d, 24e, real-time collaboration application servers 28 are shown including computer systems 28a, 28b, 28c, 28d, 28e, and other computer systems are shown including computer systems 26a, 26b, 26c, 26d, 26e. The client computer system 10, calendar and scheduling application servers 24, real-time collaboration application servers 28, and other client computer systems 26 may each, for example, include at least one processor, program storage, such as memory, for storing program code executable on the processor, and one or more input/output devices and/or interfaces, such as data communication and/or peripheral devices and/or interfaces. The client computer system 10, calendar and scheduling application servers 24, real-time collaboration application servers 28, and other client computer systems 26 are communicably connected by a communication network 22, such as a Local Area Network (LAN), the Internet, or the like. The client computer system 10, calendar and scheduling application servers 24, real-time collaboration application servers 28, and other client computer systems 26 may each further include appropriate operating system software.

As also shown in the illustrative embodiment of FIG. 1, real-time collaboration application 12, pick up meeting integration software 14, and calendar and scheduling application 16 execute on the client computer system 10 to provide a graphical user interface 18 to a user 20. For example, the user interface 18 may display one or more Web pages and/or other specific types of data or content. Calendar and scheduling application servers 24 store calendar and schedule information associated with the user 20 and various other users associated with the other client computer systems 26. Such calendar and scheduling information includes indications of times at which users have scheduled activities, and times at which users are available to schedule activities including as on-line, real-time collaboration sessions. Real-time collaboration application servers 28 store on-line availability information for the user 20 and various other users associated with the other client computer systems 26. Such on-line availability information includes indications of whether specific users are currently on-line and immediately available to participate in an on-line, real-time collaboration session.

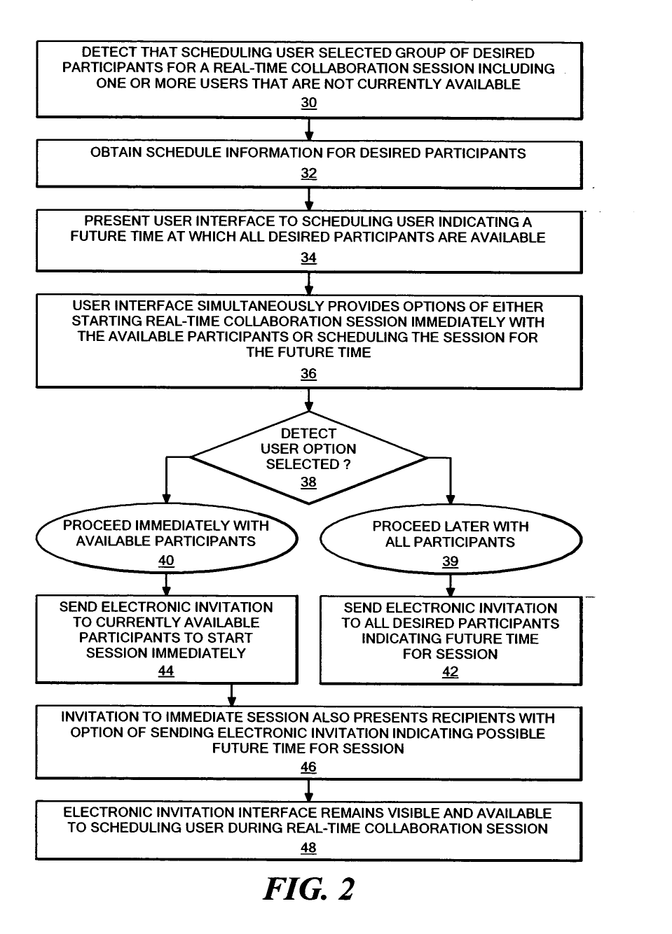

FIG. 2 is a flow chart showing steps performed by an illustrative embodiment of the disclosed system. At step 30, the disclosed system detects that a scheduling user has selected a group of desired participants for an on-line, real-time collaboration session, and that the group of desired participants includes one or more users that are not currently available to participate in an on-line, real-time collaboration session. For example, the scheduling user may have indicated a set of desired participants for a chat session using an instant messaging application program buddy list or other user interface, but one or more of the indicated participants is known by the instant messaging program to not be currently available. Availability of desired participants may be determined based on user availability information stored on one or more instant messaging server systems having instant messaging server programs executing thereon. A user may be indicated as unavailable by an instant message server because they are not currently on-line, they are not logged into the instant messaging program, they are currently participating in another collaboration session, or because they have set their current on-line status to indicate that they are not currently available.

At step 32, in response to the determination at step 30 that one or more of the desired participants for the collaboration session are not currently available, the disclosed system obtains schedule information for all the desired participants indicated by the scheduling user. For example, if the real-time collaboration application 12 of FIG. 1 determines that at least one of the desired participants is not currently available, the pick-up meeting integration software 14 may be triggered to use the calendar and scheduling application 16 to determine a future time at which all the desired participants will be available, for example by obtaining schedule information for all the desired participants. The schedule information obtained through the calendar and scheduling application 16 may include indications of future times when users associated with the client computer system 10 and the other client computer systems 26 have already scheduled activities, and future times at which they are available to schedule activities. Different ones of the users indicated as desired participants may be associated with different ones of the calendar and scheduling application servers 24. Accordingly, the pick up meeting integration software 14 may operate to obtain schedule information for different ones of the desired participants from different corresponding ones of the calendar and scheduling application servers 24, as necessary based on the calendar and scheduling servers that support the specific desired participants.

At step 34, the disclosed system determines at least one future time at which all the desired participants for the collaboration session will be available, for example based on the schedule information obtained at step 32. The future time determined at step 34 is also displayed to the scheduling user. At step 36, the user interface simultaneously provides options of either starting a real-time collaboration session immediately with the currently available participants, or of scheduling the session at the future time determined at step 34 The disclosed system then operates at step 38 to determine which of the preceding options the user has selected. If the user indicates the option 39 of proceeding later with all participants, then at step 42 the disclosed system operates to send electronic invitation messages to all the desired participants indicating the future time at which all desired participants will be available for the collaboration session. The invitation may, for example, be sent through the calendar and scheduling application 15 of FIG. 1, through an electronic mail (e-mail) application, or in some other way. Otherwise, if the user indicates option 40 of proceeding with only those desired participants that are currently available, then at step 44 the disclosed system sends electronic invitations to those currently available desired participants to start the collaboration session immediately. The electronic invitations issued at step 44 may, for example, be sent through the real-time collaboration application 12 of FIG. 1.

At step 46, the disclosed system processes the invitations issued at step 44 by presenting the invitation recipients (in this case the currently available desired participants) with a user interface simultaneously providing options of either joining the collaboration session immediately, or of sending electronic invitations to all desired participants indicating the previously determined future time at which all desired participants will be available for the collaboration session.

At step 48, the disclosed system responds to the collaboration session being started with those participants that are currently available by presenting a user interface simultaneously including both the on-line real-time collaboration session, such as a chat session, video conference or other type of collaboration session, as well as a user selectable option of sending electronic invitations to all desired participants, where the electronic invitations so generated indicate the future time at which all desired participants will be available.

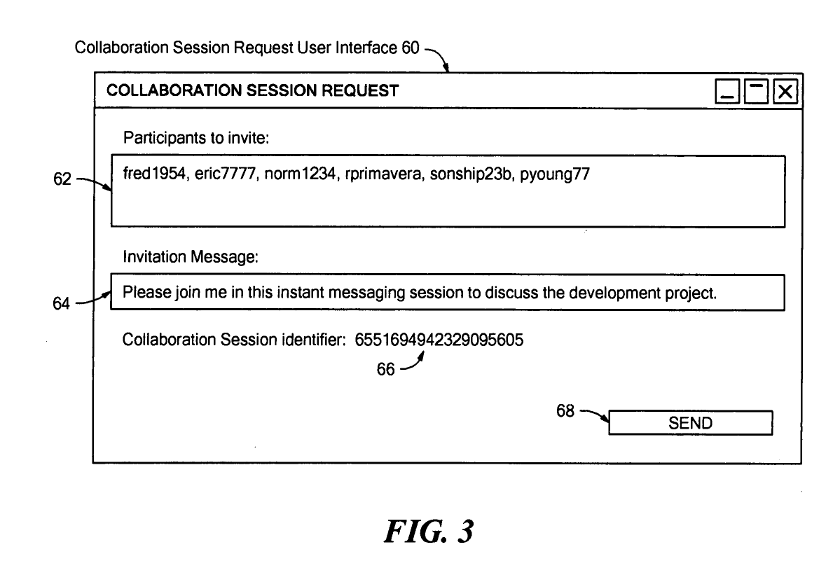

FIG. 3 is a simplified screen shot illustrating an example of a collaboration session request user interface 60 that enables a scheduling user to indicate a set of desired participants for an online, real-time collaboration session. The collaboration session request user interface 60 is shown including a field 62 into which the scheduling user enter screen names of desired participants for the collaboration session. In the example of FIG. 3, the set of desired participants is shown including fred1954, eric7777, norm1234, rprimavera, sonship23b, and pyoung77. The collaboration session request user interface 60 further includes a message field 64 into which the scheduling user enters a message to be sent together with any resulting invitation. A collaboration session identifier 66, provided for example by the real-time collaboration application 12 of FIG. 1, and associated with the requested collaboration session, is also included in the interface 60. When the user clicks on the send button 68, the disclosed system determines whether all the users indicated by the screen names entered into the field 62 are currently available for the collaboration session.

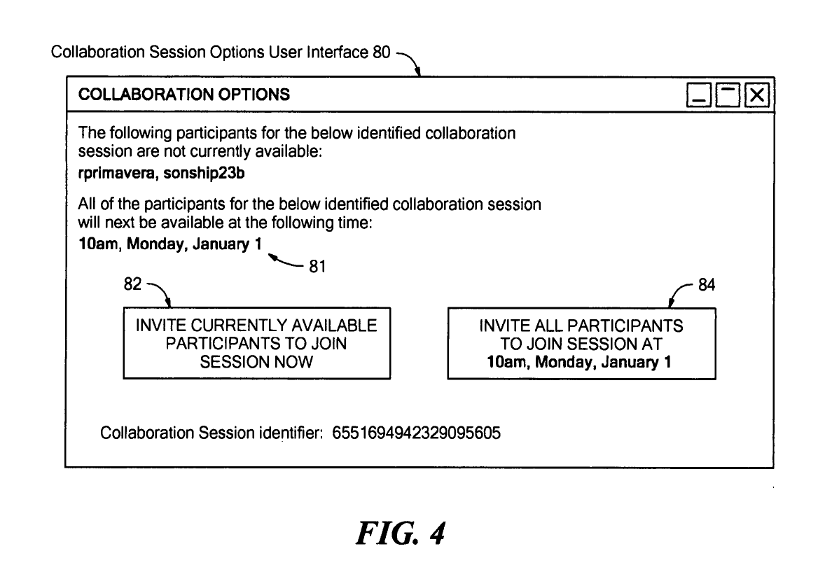

FIG. 4 shows an example of a collaboration session options user interface 80. The collaboration session options user interface 80 may, for example, be generated in response to a determination that not all of the desired participants for a requested online, real-time collaboration session are currently available. As shown in FIG. 4, the user interface 80 includes an indication 81 of at least one future time at which all the desired participants for the collaboration session will be available. If multiple future times are displayed at which all the desired participants will be available, the scheduling user may be allowed to select a preferred future time from among them. The user interface 80 further provides the scheduling user with the option of clicking on the button 82 to invite all currently available participants to immediately join the requested collaboration session. At the same time, the user interface provides the scheduling user with the option of clicking on the button 84 to invite all the desired participants to the requested collaboration session at a future time at which all the desired participants are available. The user interface 80 may also include a button or other interface component that enables the user to edit the list of desired participants, for example by returning to the collaboration session request user interface 60 of FIG. 3.

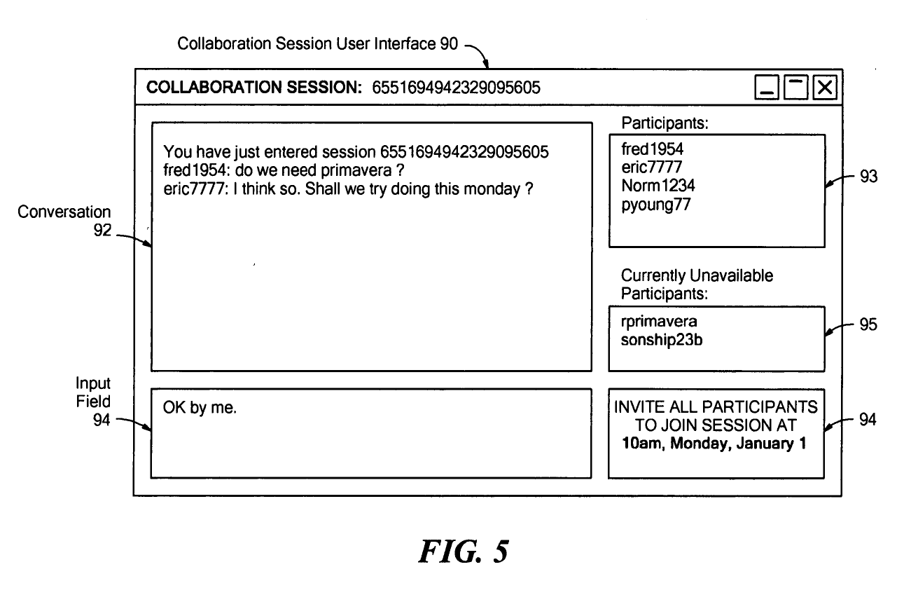

FIG. 5 shows an example of a collaboration session user interface 90 that may be generated by an embodiment of the disclosed system in the event that not all desired participants for a collaboration session are currently available, and the scheduling user has provided indication that the collaboration session is to be started immediately with those of the desired participants that are currently available. The user interface 90 is shown including a presentation of the collaboration session, shown for purposes of illustration as the chat conversation 92. An input field 94 enables the user to compose and submit text and/or other content to be included in the collaboration session. The user can click on a button 94 to cause electronic invitations to be sent out to all desired participants requesting the collaboration session to be scheduled at a future time at which all desired participants will be available. A list 93 of all currently participating users is automatically provided through the user interface 90, and a user editable list 95 contains the set of desired users that are not currently participating. The user can control the specific users to which electronic invitations are sent as a result of clicking on button 94 by adding users to and/or removing users from the set of desired participants in the list 95. The button 94 in the user interface 90 may be presented to the scheduling user only, or in an alternative embodiment to all users that are currently participating in the collaboration session. Similarly, the list 95 of users that are not currently participating may be editable by only the scheduling user, or alternatively by all users participating in the collaboration session. In an alternative embodiment, the user interface 90 further provides the ability to choose from a list of future times at which all desired participants will be available prior to clicking on the button 94.

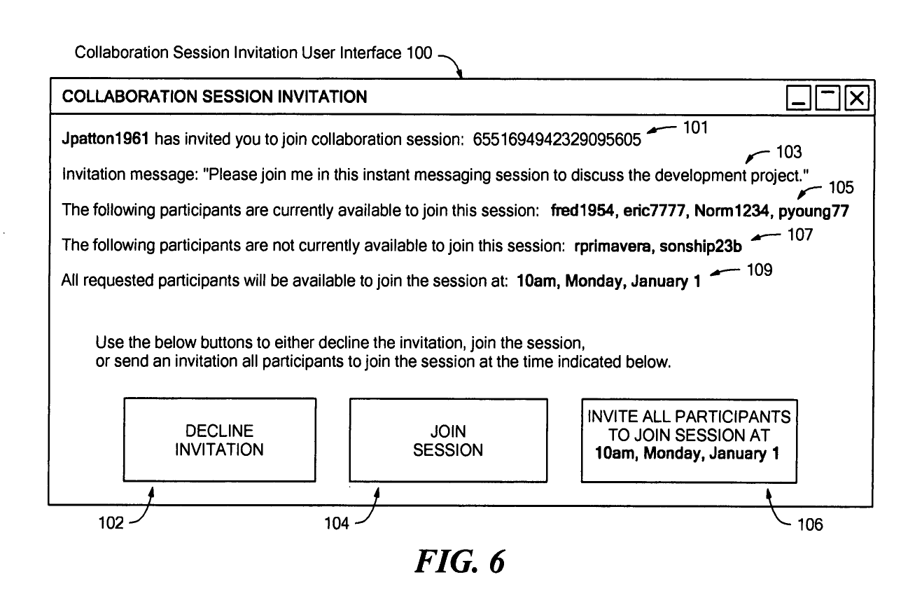

FIG. 6 shows an example of a collaboration session invitation user interface 100, presented to a user that is the recipient of an electronic invitation to immediately join an online, real-time collaboration session in an embodiment of the disclosed system. The user interface 100 is shown including a collaboration session number 101, a collaboration session invitation message 103, a list 105 of the desired participants that are currently available, and a list 107 of the desired participants that are not currently available. A future time 109 at which all desired participants will be available is also presented. In an alternative embodiment, the future time 109 may be presented as a list of future times from which the user can select the most desirable. The user interface 100 is further shown including a button 102 which the recipient can click on to decline the invitation, a button 104 which the recipient can click on to immediately join the collaboration session, and a button 106 the recipient can click on to send an electronic invitation message to all requested participants inviting them to join the session at the future time 109 at which all the desired participants will be available.

While the above description refers to embodiments of the disclosed system having specific user interface components, such as buttons, fields, specific layouts, formats, etc., the present invention is not so limited. Accordingly, those skilled in the art will recognize that alternative embodiments may use any other specific user interface components to provide information to and receive information from a user. Such alternative embodiments may use any user interface components that are selectable by a user with a mouse user interface device, keyboard, or other equivalent devices, such as pull down menus, check boxes, buddy lists, user directories, online colanders, and/or other types of user interface components. Moreover, while reference is made in the above description to instant messaging applications and chat sessions as examples of real-time collaboration applications and online, real-time collaboration sessions, the present invention is also not limited. The present invention may accordingly be embodied to operate through or in cooperation with any specific type of real-time collaboration application, to provide any specific type or kind of online, real-time collaboration session, including but not limited to video conferencing, and/or systems for sharing program or data objects between multiple users, such as a shared whiteboards, documents, applications, presentations, and/or drawings. Similarly, the present invention may be embodied to operate through or in cooperation with any specific type of calendar and scheduling application. The invitation messages generated and processed by the disclosed system may conveyed through an instant messaging application, electronic mail (e-mail) application, or any other appropriate communication application operable to deliver such invitations.

FIGS. 1 and 2 are block diagram and flowchart illustrations of methods, apparatus(s) and computer program products according to an embodiment of the invention. It will be understood that each block of FIGS. 1 and 2, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that they may be embodied using a variety of specific command structures.

I claim:

1. A method of providing an on-line, real-time collaboration session involving multiple computer system users, comprising:
determining a selected set of desired participants for said on-line, real-time collaboration;
determining that at least one of said desired participants is not currently available to participate in said on-line, real-time collaboration;
in response to said determination that at least one of said desired participants is not currently available, obtaining schedule information regarding each of said desired participants, wherein said schedule information includes an indication of a next time at which all of said desired participants will be available; and
presenting a user interface screen indicating said next time at which all of said desired participants will be available, and simultaneously enabling a user to either start said real-time collaboration session immediately with those of said desired participants that are currently available, or to schedule said real-time collaboration session at said next time at which all of said desired participants will be available.

2. The method of claim 1, further comprising:
in response to a detection of said user choosing to start said real-time collaboration session immediately, providing a user interface screen including said real-time collaboration session with said desired participants that are currently available, and wherein said user interface screen including said real-time collaboration session further simultaneously enables said user to choose to schedule said real-time collaboration session at said next time at which all of said desired participants will be available.

3. The method of claim 1, further comprising:
in response to detection of said user choosing to start said real-time collaboration session immediately, sending electronic invitations to said desired participants that are currently available, and wherein said electronic invitations are displayed such that each receiving user is provided simultaneously with the options of either joining said real-time collaboration session or scheduling said real-time collaboration at said next time at which all of said desired participants will be available.

4. The method of claim 1, further comprising:
in response to detection of said user choosing to schedule said real-time collaboration session at said next time at which all of said desired participants will be available, sending an electronic invitation to all desired participants indicating said next time at which all said desired participants will be available.

5. The method of claim 1, wherein said determining said selected set of desired participants for said on-line, real-time collaboration is performed through a real-time collaboration application, and wherein said obtaining said schedule information regarding each of said desired participants is performed through a scheduling and calendar application.

6. The method of claim 1, wherein said real-time collaboration session comprises an instant messaging chat session.

7. The method of claim 1, wherein said real-time collaboration session comprises a video conference.

8. A system including a computer readable medium, said computer readable medium having stored thereon program code for providing an on-line, real-time collaboration session involving multiple computer system users, said program code comprising:
program code for determining a selected set of desired participants for said on-line, real-time collaboration;
program code for determining that at least one of said desired participants is not currently available to participate in said on-line, real-time collaboration;
program code for, in response to said determination that at least one of said desired participants is not currently available, obtaining schedule information regarding each of said desired participants, wherein said schedule information includes an indication of a next time at which all of said desired participants will be available; and
program code for presenting a user interface screen indicating said next time at which all of said desired participants will be available, and simultaneously enabling a user to either start said real-time collaboration session immediately with those of said desired participants that are currently available, or to schedule said real-time collaboration session at said next time at which all of said desired participants will be available.

9. The system of claim 8, said program code further comprising:
program code for, in response to a detection of said user choosing to start said real-time collaboration session immediately, providing a user interface screen including said real-time collaboration session with said desired participants that are currently available, and wherein said user interface screen including said real-time collaboration session further simultaneously enables said user to choose to schedule said real-time collaboration session at said next time at which all of said desired participants will be available.

10. The system of claim 8, said program code further comprising:
program code for, in response to detection of said user choosing to start said real-time collaboration session immediately, sending electronic invitations to said desired participants that are currently available, and wherein said electronic invitations are displayed such that each receiving user is provided simultaneously with the options of either joining said real-time collaboration session or scheduling said real-time collaboration at said next time at which all of said desired participants will be available.

11. The system of claim 8, said program code further comprising:
program code for, in response to detection of said user choosing to schedule said real-time collaboration session at said next time at which all of said desired participants will be available, sending an electronic invitation to all desired participants indicating said next time at which all said desired participants will be available.

12. The system of claim 8, wherein said program code for determining said selected set of desired participants for said on-line, real-time collaboration operates through a real-time collaboration application, and wherein said program code for obtaining said schedule information regarding each of said desired participants is operates through a scheduling and calendar application.

13. The system of claim 8, wherein said real-time collaboration session comprises an instant messaging chat session.

14. The system of claim 8, wherein said real-time collaboration session comprises a video conference.

15. A computer program product including a computer readable medium, said computer readable medium having stored thereon program code for providing an on-line, real-time collaboration session involving multiple computer system users, said program code comprising:
program code for determining a selected set of desired participants for said on-line, real-time collaboration;
program code for determining that at least one of said desired participants is not currently available to participate in said on-line, real-time collaboration;
program code for, in response to said determination that at least one of said desired participants is not currently available, obtaining schedule information regarding each of said desired participants, wherein said schedule information includes an indication of a next time at which all of said desired participants will be available; and
program code for presenting a user interface screen indicating said next time at which all of said desired participants will be available, and simultaneously enabling a user to either start said real-time collaboration session immediately with those of said desired participants that are currently available, or to schedule said real-time collaboration session at said next time at which all of said desired participants will be available.

16. A computer data signal embodied in a carrier wave, said computer data signal having stored thereon program code for providing an on-line, real-time collaboration session involving multiple computer system users, said program code comprising:
program code for determining a selected set of desired participants for said on-line, real-time collaboration;
program code for determining that at least one of said desired participants is not currently available to participate in said on-line, real-time collaboration;
program code for, in response to said determination that at least one of said desired participants is not currently available, obtaining schedule information regarding each of said desired participants, wherein said schedule information includes an indication of a next time at which all of said desired participants will be available; and
program code for presenting a user interface screen indicating said next time at which all of said desired participants will be available, and simultaneously enabling a user to either start said real-time collaboration session immediately with those of said desired participants that are currently available, or to schedule said real-time collaboration session at said next time at which all of said desired participants will be available.

17. A system for providing an on-line, real-time collaboration session involving multiple computer system users, comprising:
means for determining a selected set of desired participants for said on-line, real-time collaboration;
means for determining that at least one of said desired participants is not currently available to participate in said on-line, real-time collaboration;
means for, in response to said determination that at least one of said desired participants is not currently available, obtaining schedule information regarding each of said desired participants, wherein said schedule information includes an indication of a next time at which all of said desired participants will be available; and
means for presenting a user interface screen indicating said next time at which all of said desired participants will be available, and simultaneously enabling a user to either start said real-time collaboration session immediately with those of said desired participants that are currently available, or to schedule said real-time collaboration session at said next time at which all of said desired participants will be available.
